(19) United States
(12) Patent Application Publication
(10) Pub. No.: US 2016/0073161 A1
(43) Pub. Date: Mar. 10, 2016

(54) Method and System for Scheduling Recordings of Television Programs in Television Distribution Systems

(71) Applicant: Charter Communication Operating, LLC, St. Louis, MO (US)

(72) Inventors: William Griffin Cherry, Roslindale, MA (US); Chaitanya Kanojia, West Newton, MA (US); Joseph Thaddeus Lipowski, Norwell, MA (US); Alex Moulle-Berteaux, Brooklyn, NY (US); Daniel Anil Bulli, Jamaica Plain, MA (US)

(21) Appl. No.: 14/481,665

(22) Filed: Sep. 9, 2014

(51) Int. Cl. H04N 21/458; H04N 21/4788; H04N 21/81; H04N 21/433; H04N 21/472; H04N 21/239; H04N 21/4786

(52) U.S. Cl. CPC H04N 21/458; H04N 21/2393; H04N 21/4788; H04N 21/4786; H04N 21/4334; H04N 21/47214; H04N 21/8173

(57) ABSTRACT

Messages on a social networking and/or messaging system, such as Twitter or an email system, are accessed and commands within the messages identified. Television programs indicated by the messages are also identified. From this information, commands to schedule recordings of the television programs are issued to a recording system. This provides an efficient mechanism for users to schedule recordings of programs.

### BACKGROUND OF THE INVENTION

Television content distribution systems provide the ability for their users to select television programs they wish to display and record. The television programs are usually obtained from different content data sources, such as from broadcast television, other content providers, and satellite feeds.

Traditionally, electronic program guides (EPG) have provided the users with access to the programs on the content distribution systems. The EPGs typically run on media devices such as set-top boxes. Increasingly, however, web-based interfaces have provided subscribers with the ability to access pages on the content distribution system to schedule recordings of programs.

Various systems and methods also exist that utilize social media as a component for scheduling recordings of programs. In one example, users receive messages sent from a recording system of a cable TV system. The messages include a schedule time and text associated with an upcoming featured program, and the name of the recording system's user account on the social networking system. The subscribers can then resend the messages to schedule recordings of the programs for the subscribers on their set-top boxes.

### SUMMARY OF THE INVENTION

The inventive system accesses messages on a messaging system preferably with an agent, identifies commands within the messages and television programs indicated by the messages, and applies the commands for the television programs indicated by the messages to schedule recordings of the television programs on a recording system.

Users of the messaging system are also usually subscribers or users of a content distribution system, which the recording system is a part of or works with. In one embodiment, a user/subscriber composes a message that includes programs and commands for scheduling recordings of the programs. If the user additionally includes the username of the content distribution system as a recipient or handle in the message, the agent will select the message for uploading to the content distribution system and process it as instructions to initiate or schedule a recording on the recording system.

In another example, users can access messages of the messaging system sent by other users, and can re-send/forward the messages to schedule the same recordings for themselves.

Finally, in yet another example, a user reply to or forward on other messages to schedule recordings for the follower. If the user's message does not include the username or handle of the content distribution system as a recipient, the follower can additionally include this information in the new message.

In general, according to one aspect, the invention features a method for scheduling recordings of television programs. The method comprises accessing messages on a messaging system, identifying commands within the messages and television programs indicated by the messages, and applying the commands for the television programs indicated by the messages to schedule recordings of the television programs on a recording system.

In implementations, the method verifies that the messages were sent from subscribers or users of a content distribution system and sends reply messages if the messages were not sent by the subscribers. The verification is preferably accomplished by performing a lookup of users that sent the messages in a subscriber database of the content distribution system.

In examples, the messages include tags. Tags are words or unspaced phrases preceded by one or more symbols that assist in searching for and identifying the words/phrases within the messages. The words/phrases are also known as keywords. Examples of tags include hashtags, which prefix a single ‘#’ symbol to a keyword to form the hashtag, and handles, which prefix a single ‘@’ symbol to a keyword to form the handle.

Preferably, the method identifies the commands within the messages and the television programs indicated by the messages, by parsing the messages to identify tags for the commands and the television programs indicated by the messages. The method also performs a lookup of the tags in a command tags database to find commands that correspond to the tags, and performs a lookup of the tags in a program tags database to find television programs that correspond to the tags.

The method sends reply messages in response to determining that no tags were found after parsing the messages, determining that no commands were found after performing the lookup of the tags in the command tags database, and determining that no tags for the television programs indicated by the messages were found after performing the lookup of the tags in the program tags database. The method searches for the television programs indicated by the messages in a database of television schedule information to verify that the television programs are scheduled in the future.

The method applies the commands for the television programs indicated by the messages to schedule recordings of the television programs on the recording system by first translating the commands for the television programs indicated by the messages into associated function calls for execution on the recording system. Then, the method passes the function calls to the recording system via an Application Programming Interface (“API”) of the recording system. Finally, the method invokes the function calls on the API to schedule the recordings of the television programs. Typically, invoking the function calls on the API executes machine instructions on the recording system to schedule the recordings of the television programs.

The method also sends messages from the content distribution system to users of the messaging system to announce the recordings of the television programs to the users. In examples, the messaging system is a social networking system, an electronic mail system, or a cellular text messaging system.

In general, according to another aspect, the invention features a system that includes a recording system and an agent of a content distribution system. The recording system records television programs from a content data source. The agent accesses messages on a messaging system, identifies commands within the messages and television programs indicated by the messages, and applies the commands for the television programs indicated by the messages to schedule recordings of the television programs on the recording system.

In examples, the recording system is a cloud recording system of the content distribution system or a local recording system.

In general, according to yet another aspect, the invention features a message scheduling agent of a content distribution system that schedules recordings of television programs for users. The message scheduling agent includes a message interface, a parser, and a command handler. The message interface accesses messages on a messaging system that includes user accounts of the users. The parser identifies commands within the messages and television programs indicated by the messages. The command handler translates the commands for the television programs indicated by the messages into function calls executed on a recording system to schedule the recordings of the television programs for the users.

Preferably, the parser identifies the commands within the messages and television programs indicated by the messages by identifying tags for the commands and the television programs, performing a lookup of the tags in a command tags database of the content distribution system to find commands that correspond to the tags, and performing a lookup of the tags in a program tags database of the content distribution system to find television programs that correspond to the tags.

Preferably, the tags are hashtags or handles. The command handler passes the function calls to an API of the recording system, and the API invokes the function calls to execute machine instructions associated with the commands to schedule the recordings of the television programs for the users.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram showing a content distribution system according to an embodiment of the present invention that includes a message scheduling agent and a cloud recording system, where the agent accesses messages from an external messaging system such as a social networking system, and schedules recordings of television programs indicated by the messages on the cloud recording system;

FIG. 2 is a flow chart showing a method of operation of the message scheduling agent;

FIG. 3A-3C are diagrams of different messages for scheduling recordings on the content distribution system, with FIG. 3A showing an exemplary “user-created” message sent from a user to schedule recordings for the user, FIG. 3B showing an exemplary “re-send” message, originally sent by a first user and then forwarded by a second user to schedule the same recordings for the second user as the first user, and FIG. 3C showing an exemplary “reply” message, where the “reply” message includes a message originally sent by a first user, which a second user modifies and sends to schedule recordings for the second user;

FIG. 4A-4E are diagrams of exemplary reply messages sent by the message scheduling agent to users in response to errors encountered when processing the messages;

FIG. 5A is a table of supported command tags of a command tags database, that lists different commands and command aliases that users include in the messages to scheduling recordings, and provides a description of the commands and their aliases;

FIG. 5B is a table of supported program tags of program tags database, that lists different program names and program name aliases that users include in the messages to scheduling recordings, and provides a mapping from the program tag to a resource identifier of the program that uniquely identifies the program within the content distribution system;

FIG. 6A-6B are diagrams of exemplary reply messages sent by the message scheduling agent to users in response to the content management system successfully scheduling the programs for the users; and

FIG. 7 is a block diagram showing a content distribution system according to another embodiment of the present invention in which the recording system is local to the subscriber.

### DETAILED DESCRIPTION OF THE PREFERRED EMBODIMENTS

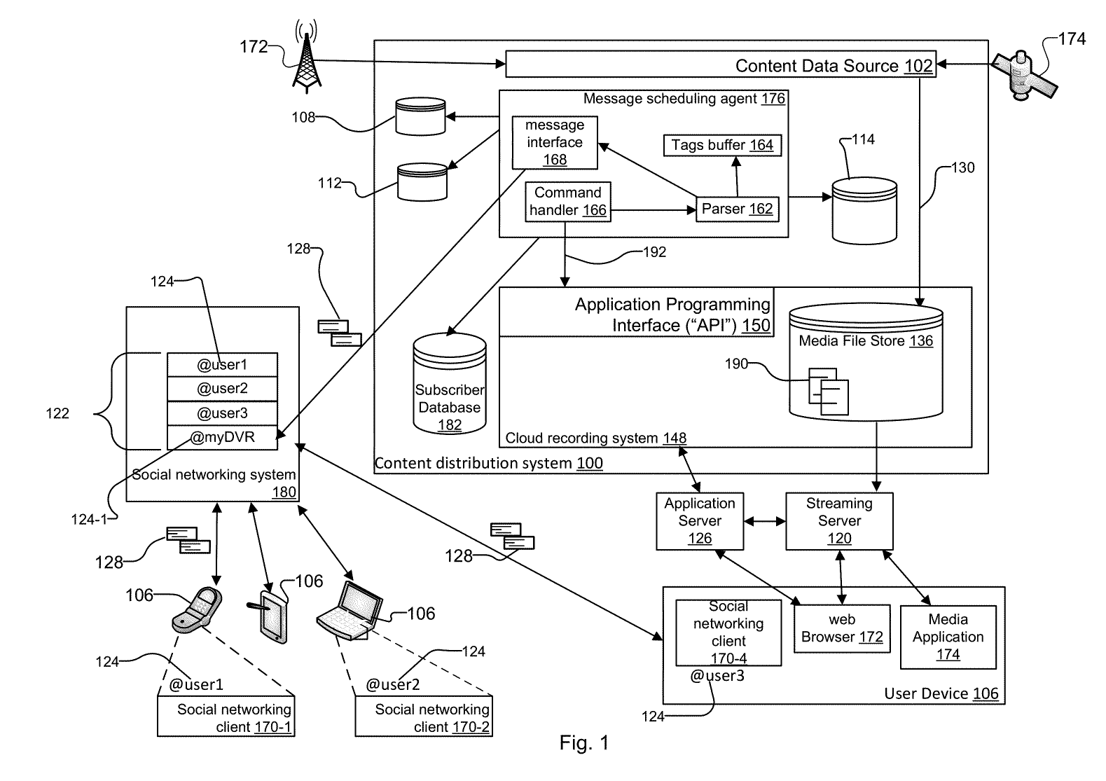

FIG. 1 shows a content distribution system 100 of a content provider according to one embodiment of the present invention. The exemplary content distribution system 100 includes a message scheduling agent operating according to the principles of the present invention.

The content distribution system 100 receives television programs from potentially multiple content data sources 102, such as broadcast television networks 172 and satellite feeds 174 and other sources, in examples. Typically, these are real-time sources of television programs that, if a user wanted to view them time-shifted, that user must schedule their recording to enable the later viewing of the programs.

While not shown in FIG. 1, note that the system 100 can include various additional software and hardware components that are typically associated with managing subscribers and delivering video content to the subscribers. Such examples include servers and systems for video advertisement insertion, on-demand/“pay per view” functionality, billing, and accounting, in addition to data communications equipment such as routers and gateways that enable communications between these different systems.

In one example, the content distribution system 100 forms part of a system for capturing and streaming over the air content to users from antennas via a packet network such as the Internet, as disclosed in U.S. patent application Ser. No. 13/299,186 filed on Nov. 17, 2011 (U.S. Pat. Pub. No.: U.S. 2012/0127374 A1), which is incorporated herein by this reference in its entirety. The system allows individual users to separately access feeds including television content from an individually-assigned antenna for recording or live streaming of the television content.

In other examples, the content distribution system 100 is a traditional cable television system that delivers content via a proprietary data network.

In still other examples, the content distribution system 100 functions to distribute video content over a cellular or mobile network to mobile computing devices.

The content distribution system 100 also includes a messaging scheduling agent (“agent”) 176, a recording system 148, a subscriber database 182, a database of television schedule information 114, a command tags database 108, and a program tags database 112.

The agent 176 accesses messages 128 from a messaging system 180, such as a social networking system, in a preferred embodiment of the invention. The agent includes a message interface 168, a command handler 166, a tags buffer 164, and a parser 162. The social networking system 180 maintains user accounts 122 for its users. Username tags 124 identify the users in messages 128 sent by the users.

Specifically, the agent 176 accesses messages 128 on the messaging system 180 typically via an account that is associated with or owned by the content distribution system 100, the system being a recipient within the messages 128. The agent 176 identifies these messages and uploads them for further processing on the content distribution system 100. For example, the agent 176 translates information from the messages 128 into function calls 192 for execution on the recording system 148 to schedule recordings of programs for users.

The recording system 148 is preferably a cloud recording system. Cloud-based recording systems typically store the recordings for the users within the service provider's content distribution system 100. The cloud recording system 148 includes a media file store 136 that stores recordings 190 for the users/subscribers. The recording system 148 also includes an API 150 that accepts the function calls 192 from the agent 176. The API 150 executes the function calls 192 on the recording system 148 to schedule recordings 190 on the content distribution system 100 for the users.

In one example, users can send messages 128 via clients (e.g., Apps or application programs) 170 such as social networking and/or messaging clients executing on their user devices 106 to schedule recordings. User devices 106 include mobile or desktop computing devices. Examples include desktop and portable computers, cellular phones, smart phones, tablets, internet-accessible television, or laptop computers, in examples. The social networking and/or messaging clients 170 execute on the user devices 106, typically within web browsers 172 or as stand-alone applications.

Users/subscribers typically control aspects of playback of their recordings via stand-alone media applications or within web browsers 172 on the user devices 106. An application server 126 communicates with the web browser/applications 172 on each user device 106 and the recording system 148.

The content distribution system 100 typically streams the television programs from the content data sources 102 as streams of real-time content 130. The streams 130 are placed in the media file store 136. A streaming server 120 loads the streams 130 from the media file store 136 and buffers the streams 130 for playback to each user. The streams 130 are typically viewed by users on a web browser 172 or other media or player application 174 on their user devices 106 or other devices capable of displaying streamed content, in examples.

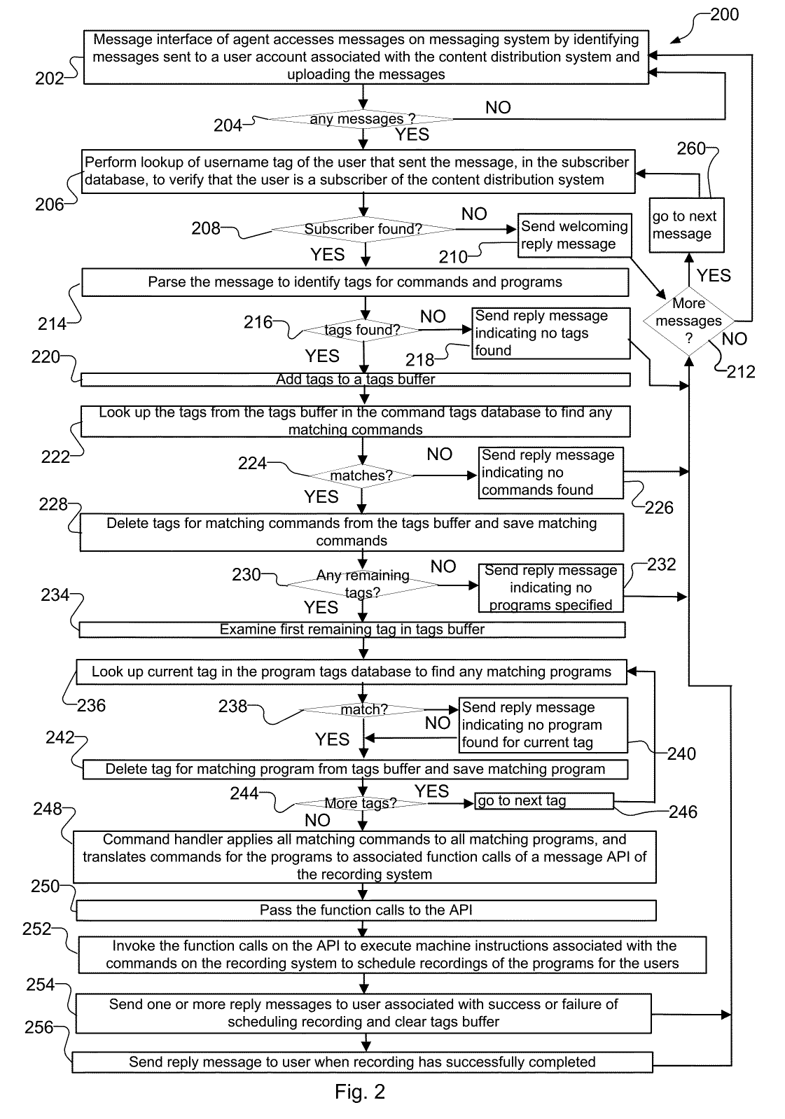

FIG. 2 illustrates method 200 associated with the operation of the agent 176 of the content distribution system 100.

In step 202, the message interface 168 of the agent 176 accesses messages 128 on the messaging system 180 by identifying messages 128 typically sent to a user account 122 associated with the content distribution system 100, and uploading the messages 128. Because the messages 128 are be sent by users asynchronously, the agent 176 preferably polls the messaging system at a configurable interval to seek and upload new messages. Typically, the agent 176 accesses its account on the messaging system 180 at least hourly.

In step 204, the agent 176 tests if any messages 128 were uploaded, and transitions to step 202 to access more messages from the messaging system 180 if this condition is false. Otherwise, processing continues in step 206.

According to step 206, the agent 176 performs a lookup of a username tag or sender ID 124 of the user that sent the message 128, in the subscriber database 182, to verify that the user is a subscriber or registered user of the content distribution system 100. The subscriber database 182 includes entries for subscribers. Each entry includes a username tag 124 for the subscriber's associated user account 122 on the messaging system 180.

While the subscriber database 182 is included as part of the content distribution system 100, the subscriber database 182 can also reside within a customer management system that is external to the content distribution system 100, in another example. In such a configuration, the agent 176 communicates with the customer management system to obtain the subscriber entries from the subscriber database 182.

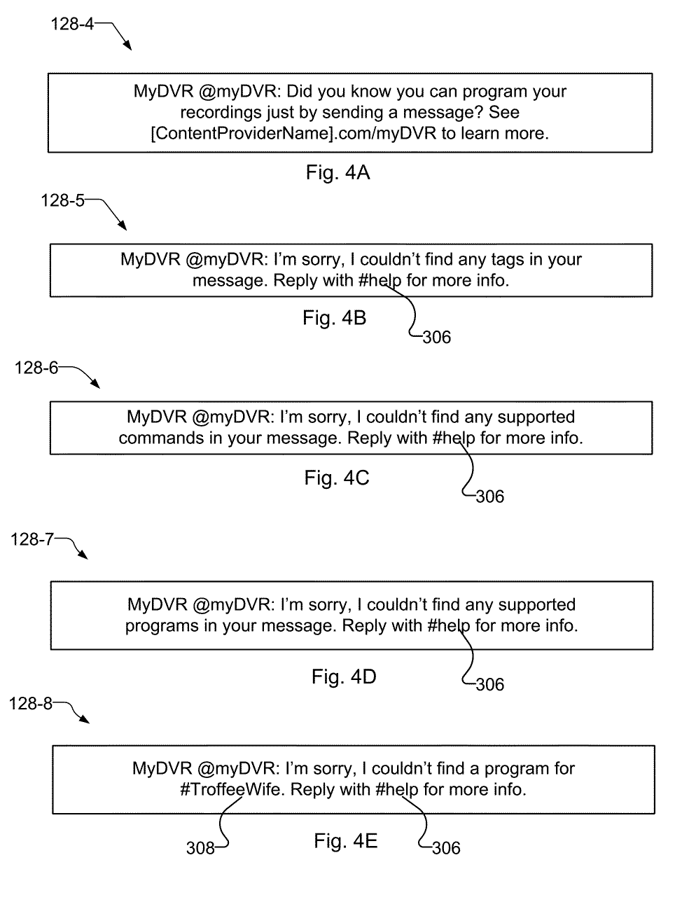

In step 208, the agent 176 determines if a subscriber or user was found in the subscriber database 182 for the user that sent the message. If no subscriber was found, the agent transitions to step 210, and sends a welcoming reply message 128-4 as shown in FIG. 4A to the user.

FIG. 4A shows an example of the welcoming reply message 128-4, which encourages the user to subscribe to the content distribution system 100 and to avail themselves of the ability to schedule recordings from messages 128. One example of a reply is “MyDVR @myDVR: Did you know you can program your recordings just by sending a message? See [ContentProviderName].com/myDVR to learn more.”

Returning to method 200 of FIG. 2, upon completion of step 210, the agent 176 transitions to step 212 to determine if there any more messages to process. If there are more messages, the agent 176 transitions to step 260 to go to the next message. If there are no more messages to process in step 212, the agent 176 transitions back to step 202 to seek more messages from the social networking or messaging system 180.

If the agent in step 208 determines that a subscriber associated with the user was found, the agent 126 transitions to step 214 to parse the message and identify tags for commands and programs within the message.

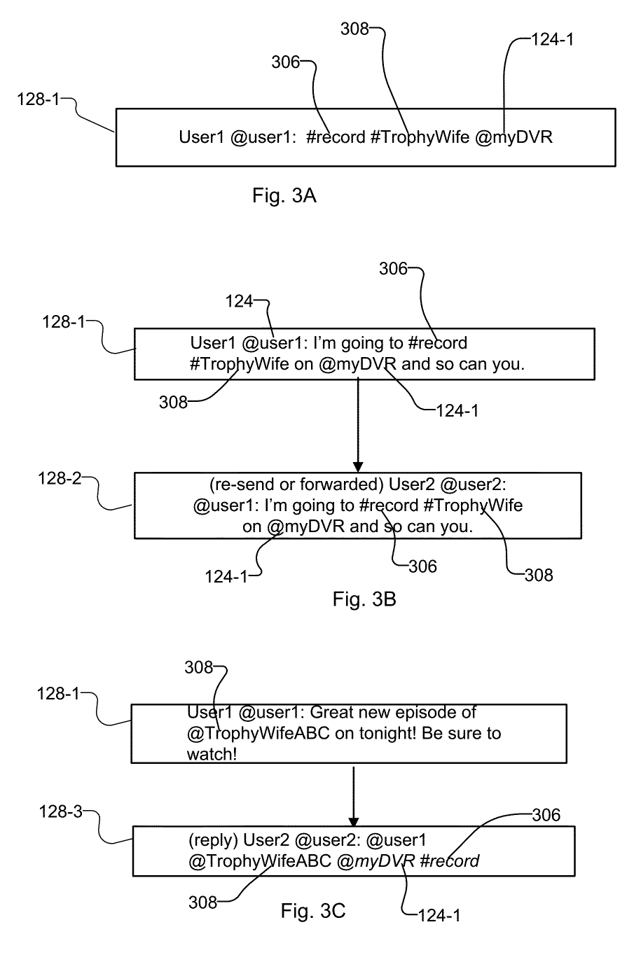

FIG. 3A-3C show different examples of messages 128-1 through 128-3, respectively, sent by users of the social networking system 180. The users send the messages 128, in one example, via social networking clients 170 executing on user devices 106 to schedule recordings on the content distribution system 100. The social networking or messaging system 180 receives and stores the messages 128 in a user account 122 for each user.

Examples of the social networking systems includes systems such as Twitter,

Instagram, Facebook, MySpace, Digg, Yahoo Groups and any number of other social networks that are privately or publicly available. In other examples, the messages were sent via standard messaging clients such as cellular text messages, iMessage, WhatApp, to list a few examples.

As mentioned previously, the messages 128 include tags. Tags are words or unspaced phrases preceded by one or more symbols that assist in searching for and identifying the words/phrases within the messages 128. The words/phrases are also known as keywords. Examples of tags include hashtags, which prefix a single ‘#’ symbol to a keyword to form the hashtag, and handles, which prefix a single ‘@’ symbol to a keyword to form the handle.

The messages 128 include tags such as command tags 306, program tags 308, and username tags 124 to represent commands, programs, and usernames, respectively. In the preferred embodiment, to schedule recordings from messages, the messages 128 usually include a tag for at least one command and a tag for at least one television program. They can further include a tag that identifies a username of the user account 122 associated with the content distribution system 100. This name is typically reserved such that it is unique across all user, command, and program namespaces. In the exemplary messages, this tag, or username tag 124-1, is handle ‘@myDVR’. The format and types of the tags that the messages 128 and the agent 176 support are also known as a tags schema.

In a preferred embodiment, the tags schema for messages 128-1 through 128-3 requires that the username tags 124 are handles and that the command tags 306 and program tags 308 are either handles or hashtags. This is because these tag types are ubiquitously featured and utilized in existing social messaging systems 180 such as Twitter, HubSpot, Google+, and Instagram, in examples. As a result of using the preferred tags schema implementation, however, the namespaces of the commands in the command tag database 108 and the programs in the program tag database 112 should not overlap.

Other tags schema implementations can also be utilized. In another tags schema example, a dedicated tag type is associated with each required message element. In the example, users specify hashtags for programs, handles for users, and a newly-defined tag, such as “%command-name”, for commands. While this tags schema simplifies parsing of the messages and lookup of the commands, programs, and usernames, it is also less user-friendly than the preferred tags schema of messages 128-1 through 128-3.

FIG. 3A shows a first message 128-1 for scheduling recordings for users on the content distribution system 100. In the example, the user is identified by a username tag 124, handle ‘@user1’ or simply by being the sender of the message. The message 128-1 includes a username tag 124-1 for reserved handle ‘@myDVR’, a command tag 306 that uses hashtag ‘#record’, and a program tag 308 that uses hashtag ‘#TrophyWife’.

Message 128-1 is an example of a “user-created” message, where the user schedules recordings by composing a message that includes tags for commands and programs, and specifies the username tag 124-1 for the user account 122 associated with the content distribution system 100 as the recipient in the message.

When creating the user-created messages 128-1, users can include multiple command tags 306 and/or program tags 308 within the messages in one embodiment. This provides the ability to schedule recordings for multiple programs in a single message, or apply multiple commands to one or more programs in a single message, in examples.

Additionally, when the social networking messaging system 180 is Twitter, the “user-created” message corresponds to a tweet.

FIG. 3B shows a second message 128-2 for scheduling recordings 190 for users on the content distribution system 100. In the example, a user, identified by username tag 124 ‘@user1’ or by the source of the message, first sends a user-created message 128-1 to schedule a recording for user1, as in FIG. 3A. Other users of the social networking system 180, such as user2 in the example, can access messages sent by other users, such as user1. Moreover, the other users need not be followers of user1 to have access to the user-created message 128-1 sent by user1.

Message 128-2 is an example of a “re-send” message embodiment for scheduling recordings for users on the content distribution system 100. In the message 128-2, user2 is identified by username tag 124 ‘@user2’ and forwards user1's original message 128-1 to the same recipient, ‘@myDVR’. As a result, user 2 schedules the same recordings 190 on the content distribution system 100 as scheduled by user1, by simply resending or forwarding user1's message. Additionally, when the social networking system 180 is Twitter, the “re-send” message sent by the second user corresponds to a re-tweet of the first user's tweet.

FIG. 3C shows a third example of a message 128-2 for scheduling recordings for users on the content distribution system 100. In the example, a user identified by username tag 124 ‘@user1’ first sends a message 128. User1 sends the message to tell his/her followers that the program indicated by handle ‘@TrophyWifeABC’ is airing tonight. The message 128 does not have all required elements to schedule a recording for user1, however. User2, a follower of user1, receives the message 128, and modifies the message to create message 128-3 to schedule recordings for user2.

Message 128-3 is an example of a “reply” message embodiment for scheduling recordings for users on the content distribution system 100. User2 has modified the message to include a supported command tag 306, ‘#record’, and the reserved handle ‘@myDVR’ as the recipient. This provides user2 with the ability to schedule recordings for the programs specified by user1's message.

As with the user-created messages 128-1, users composing reply messages 128-3 can includes multiple command tags 306 and/or program tags 308 within the messages. Additionally, when the social networking system 180 is Twitter, the “reply” message by the second user corresponds to either a quote-tweet or a reply of a first user's tweet, where the second user is a follower of the first user.

Returning to method 200 of FIG. 2, the agent 176 parses the current message 128 to identify tags for commands and programs in step 214. Note that the tags schema used by the parser 164 and the messages 128 must be compatible. The agent 176 uses its parser 162 to identify tags ‘#record’, ‘#TrophyWife’ and ‘@myDVR’ in message 128-1. The parser 162 then removes ‘@myDVR’ from consideration, as it is the reserved username tag 124-1 associated with the user account 122 of the content distribution system 100. Because the parser 162 found tags in step 216, the parser 162 adds the tags found, ‘#record’ and ‘#TrophyWife’, to a tags buffer 164 in step 220.

However, if no tags were found in step 216, the agent 176 transitions to step 218, and sends the reply message 128-5 of FIG. 4B to accordingly notify the user.

In other examples, the handle of the content distribution system, e.g., ‘@myDVR’ is not required. Instead the user simply sends a message directly to the account on the messaging system 180 associated with the content distribution system.

Returning to method 200, at the completion of step 220, the agent transitions to step 222. Here, the agent 176 performs a lookup of the tags from the tags buffer 164 in the command tags database 108 to find any matching commands.

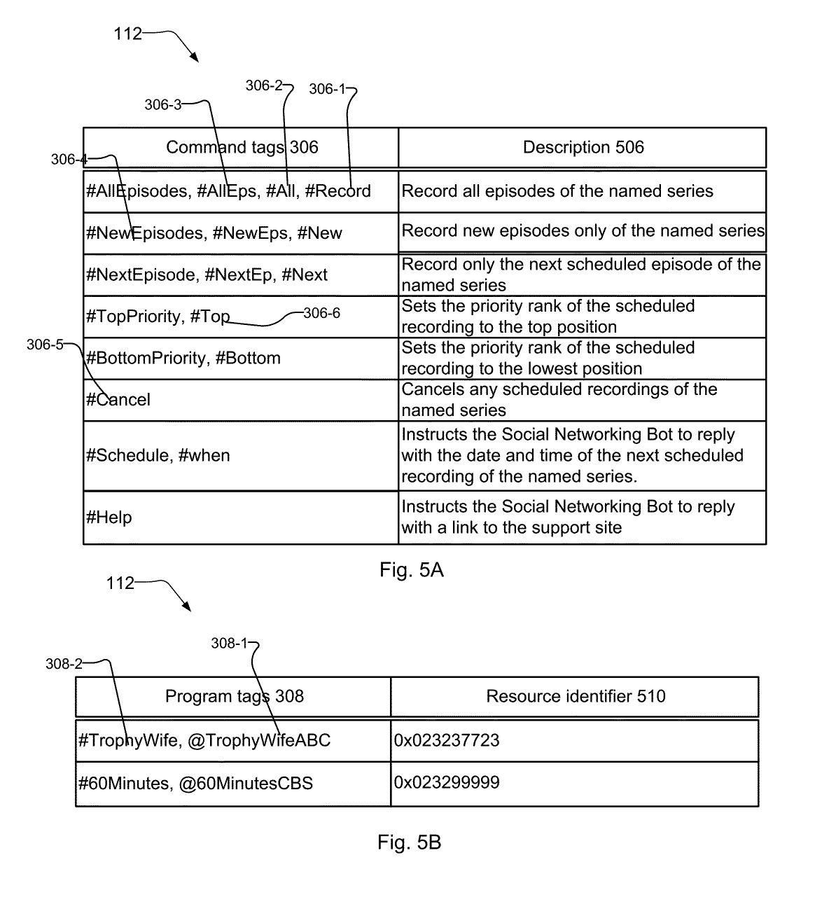

FIG. 5A shows an exemplary table of command tags 306 for supported commands in the command tags database 108. The table includes a description 506 for each command tag 306. Of the command tags 306, users can specify multiple command tags 306 for the same command, also known as aliases. For example, command tag 306-1, ‘#record’, has aliases 306-2, ‘#All’, 306-3, ‘#AllEps’, and 306-4, ‘#AllEpisodes’.

In addition to scheduling recordings, the commands tags 306 provide the ability for users to manage certain aspects of the recordings 192 via messages 128. For example, users can send messages that include tags such as command tag 306-5, ‘#cancel’ , to cancel a currently scheduled recording, and command tag 306-6, ‘#top’, to set the priority rank of a program that is scheduled for recording to be at the top of the user's recording queue.

Returning to method 200, at step 224, the agent 176 finds a match for tag ‘#record’ in the command tags database 108, and as a result, identifies this tag as a command tag 306. This process repeats for all tags in the tags buffer 164. Because of the preferred user-friendly tags schema utilized, once a first matching command tag is found, all remaining tags that do not match commands are treated as potentially valid program tags and remain in the tags buffer 164.

However, in step 224, if none of the tags in the tags buffer 164 matches commands from the command tags database 108, the agent 176 transitions to step 226, and sends the reply message 128-6 of FIG. 4C to indicate that the user did not provide any supported commands in their original message 128.

In response to finding at least one command in step 224, in step 228, the agent 176 deletes the tags associated with the matching commands from the tags buffer 164, and saves all matching commands to a buffer. As a result, any tags remaining in step 230 are considered to be potentially valid program tags 308.

However, in step 230, if no tags remain in the tags buffer 164, the agent 176 transitions to step 232 and sends message 128-7 of FIG. 4D to notify the user that the user did specify any supported commands in their message 128-1.

Because tag/program tag 308 ‘#TrophyWife’ remains in the tags buffer 164, in the current example, according to step 234, the agent 176 examines the first tag in the tags buffer 164. In step 236, the agent 176 performs a lookup of the current tag in the program tags database 112 to find any matching programs.

FIG. 5B shows an exemplary table of supported program tags 308 of the program tags database 112. The program tags database 112 provides a mapping between supported program tags 308 for the programs, and unique resource identifiers 510 for the programs in the content distribution system 100. In one implementation, the program tags database 112 can support multiple program tags 308 or aliases for a given program, similar to the notion of the command tag alias. For example, program tag 308-1, ‘#TrophyWifeABC’, has alias 308-2, ‘#TrophyWife’.

Returning to method 200 step 238, because the agent 176 finds a match for tag ‘#TrophyWife’ in the program tags database 1, the agent 176 identifies this tag as a matching program tag 308. The agent 176 transitions to step 242 and deletes the tag for the matching program from the tags buffer 164 and saves the matching program to a buffer.

Then, the agent transitions to step 244 to determine if more tags exist in the tags buffer 164. If this condition is true, the agent 176 transitions to step 246 to go to the next tag, which in turn transitions back to step 236 to the top of the current processing loop.

When the agent 176 in step 238 does not find a program in the program tags database 112 that matches the current tag, the agent 176 transitions to step 240 and sends message 128-8 of FIG. 4E to notify the user that the specified program is not supported. The agent 176 then transitions to step 242 to delete the current tag from the tags buffer 164. When at least one matching command has been found and there are no more tags remaining in the tags buffer 164, the agent 176 transitions to step 248.

In step 248, the command handler 166 of the agent 176 retrieves the matched commands saved in step 228 and each of the matched programs saved in one or more iterations of step 242. Then, the command handler 166 applies all matching commands to all matching programs, and translates the commands for the programs to associated function calls 192 of the API 150 of the recording system 148. In the present embodiment, the recording system 148 is the cloud recording system of the content distribution system 100. The command handler 166 then passes the function calls 192 to the API 150 in step 250.

In step 252, the API 150 invokes the function calls 192 to execute machine instructions associated with the commands on the recording system 148 to schedule recordings of the programs for the users. In step 254, the agent 176 sends one or more reply messages to the user associated with the success or failure of scheduling the recording, and clears the tags buffer 164 in anticipation of processing tags for more messages in step 212.

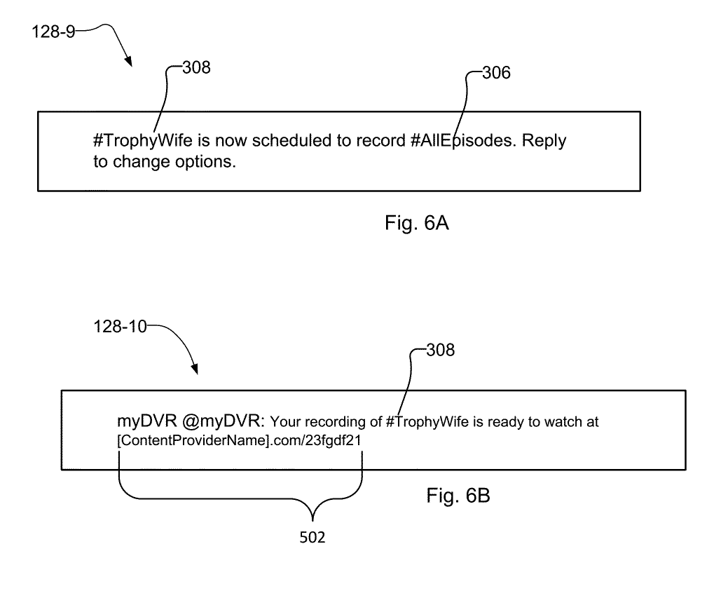

FIG. 6A is an exemplary recording announcement message 128-9 that the agent 176 sends to the user in step 254 when scheduling of the recording was successful. The message 128-10 includes the program tags 308 and command tags 306 associated with the recording. Not only does this announce the recording to the users, but it also enables other users to reply to this message to schedule the same recordings for the other users.

FIG. 6B is an exemplary recording success message 128-10 that the agent 176 sends to the user in step 256 when the recording has successfully completed. The message 128-10 includes the program tag 308 and text indicating that the recording was successful, and a URL 502 that the user can enter on a web browser 172 or media application 174 to access the recording 190 on the recording system 148.

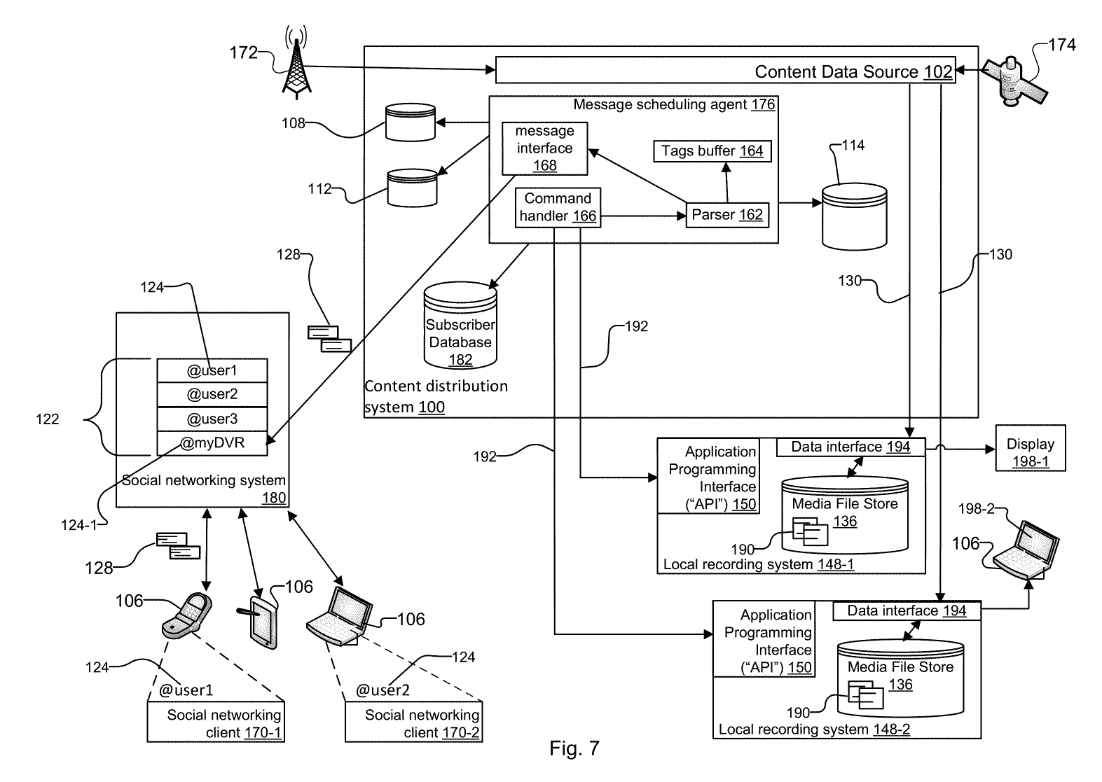

FIG. 7 shows a content distribution system 100 of a content provider according to another embodiment of the present invention. The system 100 includes a message scheduling agent 176 that communicates with a messaging system 180 and schedules recordings for users from messages 128.

The content distribution system 100 schedules recordings for each subscriber on hardware located within each subscriber's premises. Exemplary local recording systems 148-1 and 148-2 are associated with different subscribers. The local recording systems 148 display video data on a display 198. In one example, local recording system 148-1 displays video data for streams 130 and recorded programs 190 on a TV monitor as the display 198-1. In another example, local recording system 148-2 displays video data for recorded programs 190 over a wireless connection to a display 198-2 of a user device 106 such as a tablet or cellular phone. The wireless connection can be a cellular network or Wi-Fi connection, in examples.

The local recording systems 148 schedule the recordings by invoking function calls 192 issued by the content distribution system 100. The function calls 192 include commands to schedule recordings for the users.

In one example, local recording systems 148-1 and 148-2 include a data interface 194, an Application Programming Interface (“API”) 150, and a Media file store 136. The data interface 194 receives streams 130 that are provided by content data sources 102 of the content distribution system 100. The local recording systems 148 record the streams 130 in response to processing the function calls 192, and save the completed recordings 190 onto the media file store 136. The data interface 194 also retrieves recordings 190 and displays the recordings 190 onto the displays 198-1 and 198-2.

The command handler 166 determines which commands and programs are for each user's local recording system 148. The command handler 166 translates the commands for the programs to associated function calls 192, and passes the function calls 192 to the API 150 of the appropriate local recording system 148. The command handler 166 can utilize various communications protocols over a data network such as the Internet to provide the function calls 192 to the APIs 150 of the appropriate local recording systems 148, in one example.

In addition, the command handler 166 can be programmed to include vendor-specific function calls 192 that match the interfaces/APIs 150 of each vendor's local recording system 148. Vendors of local recording systems 148 include TWO, Pace Networks, Cisco Systems, Arris/Motorola, Huluplus, Samsung, Sony, and Channel Master TV, in examples.

In another implementation, each vendor's local recording system 148 presents a common API 150 for the function calls 192 sent by the command handler 166. Then, within each API 150, vendor-specific machine instructions are created to schedule recordings of the programs for the users.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for scheduling recording of television programs, the method comprising:
accessing messages on a messaging system;
identifying commands within the messages and television programs indicated by the messages; and
applying the commands for the television programs indicated by the messages to schedule recordings of the television programs on a recording system.

2. The method of claim 1, further comprising verifying that the messages were sent from subscribers of a content distribution system and sending reply messages if the messages were not sent by the subscribers.

3. The method of claim 2, wherein verifying that the messages were sent from the subscribers of the content distribution system comprises performing a lookup of users that sent the messages in a subscriber database of the content distribution system.

4. The method of claim 1, wherein identifying the commands within the messages and the television programs indicated by the messages comprises:
parsing the messages to identify tags for the commands and the television programs indicated by the messages;
performing a lookup of the tags in a command tags database to find commands that correspond to the tags; and
performing a lookup of the tags in a program tags database to find television programs that correspond to the tags.

5. The method of claim 4, further comprising sending reply messages in response to:
determining that no tags were found after parsing the messages;
determining that no commands were found after performing the lookup of the tags in the command tags database; and
determining that no tags for the television programs indicated by the messages were found after performing the lookup of the tags in the program tags database.

6. The method according to claim 4, wherein the tags are hashtags.

7. The method according to claim 4, wherein the tags are handles.

8. The method of claim 1, further comprising searching for the television programs indicated by the messages in a database of television schedule information to verify that the television programs are scheduled in the future.

9. The method according to claim 1, wherein applying the commands for the television programs indicated by the messages to schedule recordings of the television programs on the recording system comprises:
translating the commands for the television programs indicated by the messages into associated function calls for execution on the recording system ;
passing the function calls to the recording system via an Application Programming Interface (“API”) of the recording system; and
invoking the function calls on the API to schedule the recordings of the television programs.

10. The method according to claim 9, wherein invoking the function calls on the API executes machine instructions on the recording system to schedule the recordings of the television programs.

11. The method according to claim 1, further comprising sending messages from a content distribution system to users of the messaging system to announce the recordings of the television programs to the users.

12. The method according to claim 1, wherein the messaging system is a social networking system.

13. The method according to claim 1, wherein the messaging system is an electronic mail system.

14. The method according to claim 1, wherein the messaging system is a cellular text messaging system.

15. A system, comprising:
a recording system that records television programs from a content data source; and
an agent of a content distribution system that accesses messages on a messaging system, identifies commands within the messages and television programs indicated by the messages, and applies the commands for the television programs indicated by the messages to schedule recordings of the television programs on the recording system.

16. The system of claim 15, wherein the messaging system is a social networking system.

17. The system of claim 15, wherein the messaging system is an electronic mail system.

18. The system of claim 15, wherein the messaging system is a cellular text messaging system.

19. The system of claim 15, wherein the agent verifies that the messages were sent from subscribers of the content distribution system by performing a lookup of users that sent the messages in a subscriber database of the content distribution system.

20. The system of claim 15, wherein the recording system is a cloud recording system of the content distribution system.

21. The system of claim 15, wherein the recording system is a local recording system.

22. A message scheduling agent of a content distribution system that schedules recordings of television programs for users, the message scheduling agent comprising:
a message interface that accesses messages on a messaging system that includes user accounts of the users;
a parser that identifies commands within the messages and television programs indicated by the messages; and
a command handler that translates the commands for the television programs indicated by the messages into function calls executed on a recording system to schedule the recordings of the television programs for the users.

23. The agent of claim 22, wherein the parser identifies the commands within the messages and television programs indicated by the messages by:
parsing the messages to identify tags for the commands and the television programs indicated by the messages;
performing a lookup of the tags in a command tags database of the content distribution system to find commands that correspond to the tags; and
performing a lookup of the tags in a program tags database of the content distribution system to find television programs that correspond to the tags.

24. The agent of claim 23, wherein the tags are hashtags or handles.

25. The agent of claim 22, wherein the command handler passes the function calls to an Application Programming Interface (“API”) of the recording system, and the API invokes the function calls to execute machine instructions associated with the commands to schedule the recordings of the television programs for the users.
